(19) United States
(12) Patent Application Publication
(10) Pub. No.: US 2012/0113875 A1
(43) Pub. Date: May 10, 2012

(54) METHOD AND APPARATUS FOR DYNAMICALLY MODIFYING A TRANSMISSION FRAME

(75) Inventors: Seppo Alanärä, Oulu (FI); Lars Dalsgaard, Oulu (FI)

(73) Assignee: NOKIA CORPORATION, Espoo (FI)

(21) Appl. No.: 13/146,494

(22) PCT Filed: Jan. 25, 2010
(86) PCT No.: PCT/FI10/50036

§ 371 Date: Jan. 18, 2012

Related U.S. Application Data
(60) Provisional application No. 61/147,522, filed on Jan. 27, 2009.

(51) Int. Cl. H04W 36/00; H04J 3/00

(52) U.S. Cl. 370/280

(57) ABSTRACT

An approach for dynamically modifying a transmission frame. A logic determines whether to modify a configuration of a transmission frame, including a time division duplex frame structure, for transmission over a cell and modifies the configuration of the transmission frame for transmission over the cell based on the determination. A transceiver then signals the modified configuration to a user equipment configured within the cell.

### RELATED APPLICATIONS

This application claims the benefit of the earlier filing date under 35 U.S.C. §119(e) of U.S. Provisional Application Ser. No. 61/147,522 filed Jan. 27, 2009, entitled “Method and Apparatus for Dynamically Modifying a Transmission Frame,” the entirety of which is incorporated herein by reference.

### BACKGROUND

Radio communication systems, such as wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves the design of radio transmission frames that can efficiently utilize network resources. Traditionally, the configuration of these transmission frames is static or semi-static, at best. Hence, such frame configurations can unnecessarily consume network resources, when conditions (e.g., traffic loading) change.

Therefore, there is a need for an approach for providing configuration patterns of a radio transmission frame, which can co-exist with already developed standards and protocols.

### SOME EXAMPLE EMBODIMENTS

According to one embodiment, a method comprises determining whether to modify a configuration of a transmission frame, including a time division duplex frame structure, for transmission over a cell. The method also comprises modifying the configuration of the transmission frame for transmission over the cell based on the determination. The method further comprises signaling the modified configuration to a user equipment configured within the cell.

According to another embodiment, a computer-readable medium carries one or more sequences of one or more instructions which, when executed by one or more processors, cause an apparatus to determine whether to modify a configuration of a transmission frame, including a time division duplex frame structure, for transmission over a cell. The apparatus is also caused to modify the configuration of the transmission frame for transmission over the cell based on the determination. The apparatus is further caused to signal the modified configuration to a user equipment configured within the cell.

According to another embodiment, an apparatus comprises a logic configured to determine whether to modify a configuration of a transmission frame, including a time division duplex frame structure, for transmission over a cell. The logic is also configured to modify the configuration of the transmission frame for transmission over the cell based on the determined characteristic. The apparatus further comprises a transceiver configured to signal the modified configuration to a user equipment configured within the cell.

According to another embodiment, an apparatus comprises means for determining whether to modify a configuration of a transmission frame, including a time division duplex frame structure, for transmission over a cell. The apparatus also comprises means for modifying the configuration of the transmission frame for transmission over the cell based on the determined characteristic. The apparatus further comprises means for signaling the modified configuration to a user equipment configured within the cell.

According to another embodiment, a method comprises receiving, within a cell, a message specifying reconfiguration of a transmission frame including a time division duplex frame structure. The aforementioned reconfiguration is based on determining whether to modify a configuration of the transmission frame for transmission over the cell.

According to another embodiment, a computer-readable medium carries one or more sequences of one or more instructions which, when executed by one or more processors, cause an apparatus to receive, within a cell, a message specifying reconfiguration of a transmission frame including a time division duplex frame structure. The aforementioned reconfiguration is based on determining whether to modify a configuration of the transmission frame for transmission over the cell.

According to another embodiment, an apparatus comprises a transceiver configured to receive, within a cell, a message specifying reconfiguration of a transmission frame including a time division duplex frame structure. The aforementioned reconfiguration is based on determining whether to modify a configuration of the transmission frame for transmission over the cell.

According to yet another embodiment, an apparatus comprises means for receiving, within a cell, a message specifying reconfiguration of a transmission frame including a time division duplex frame structure. The aforementioned reconfiguration is based on determining whether to modify a configuration of the transmission frame for transmission over the cell.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

FIG. 1 is a diagram of a communication system capable of dynamically configuring a radio transmission frame pattern, according to an exemplary embodiment;

FIG. 2 is a flowchart of a process for dynamically configuring a radio transmission frame pattern, according to an exemplary embodiment;

FIGS. 3A and 3B are diagrams of radio transmission frame structures, according to various exemplary embodiments;

FIGS. 4A-4D are diagrams of communication systems having exemplary long-term evolution (LTE) architectures, in which the user equipment (UE) and the base station of FIG. 1 can operate, according to various exemplary embodiments;

FIG. 5 is a diagram of hardware that can be used to implement an embodiment of the invention; and

FIG. 6 is a diagram of exemplary components of an LTE terminal configured to operate in the systems of FIGS. 4A-4D, according to an embodiment of the invention.

### DESCRIPTION OF SOME EMBODIMENTS

An apparatus, method, and software for dynamically configuring a radio transmission frame pattern are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the Third Generation Partnership Project (3GPP) Long Term Evolution (LTE) architecture, it is recognized by one of ordinary skill in the art that the embodiments of the inventions have applicability to any type of communication system and equivalent functional capabilities.

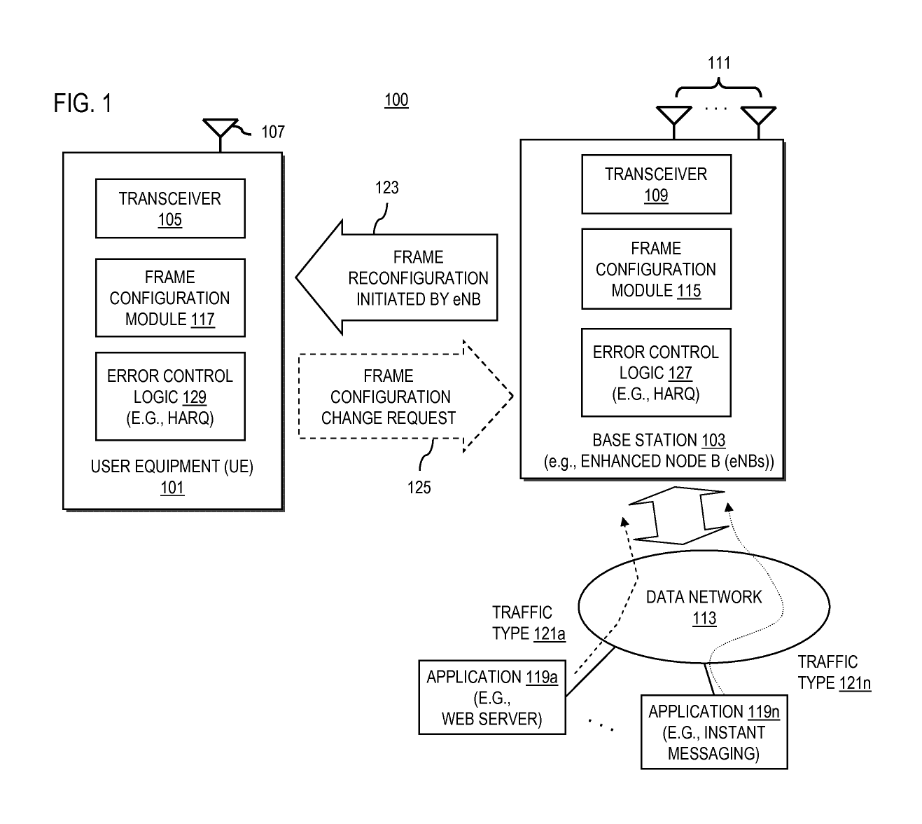

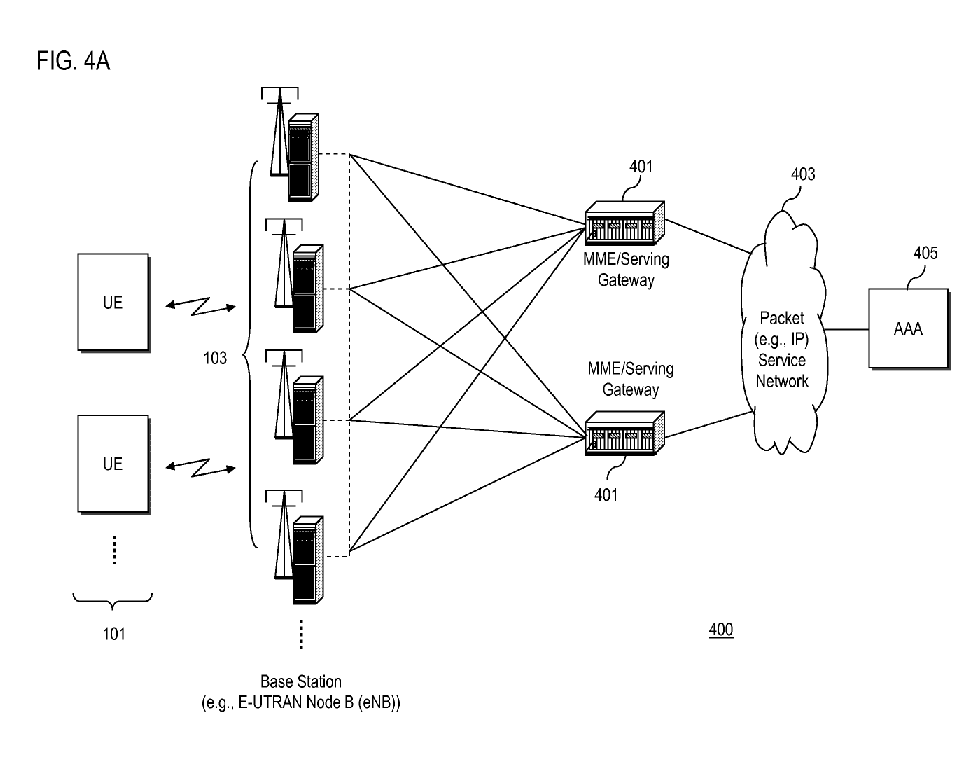

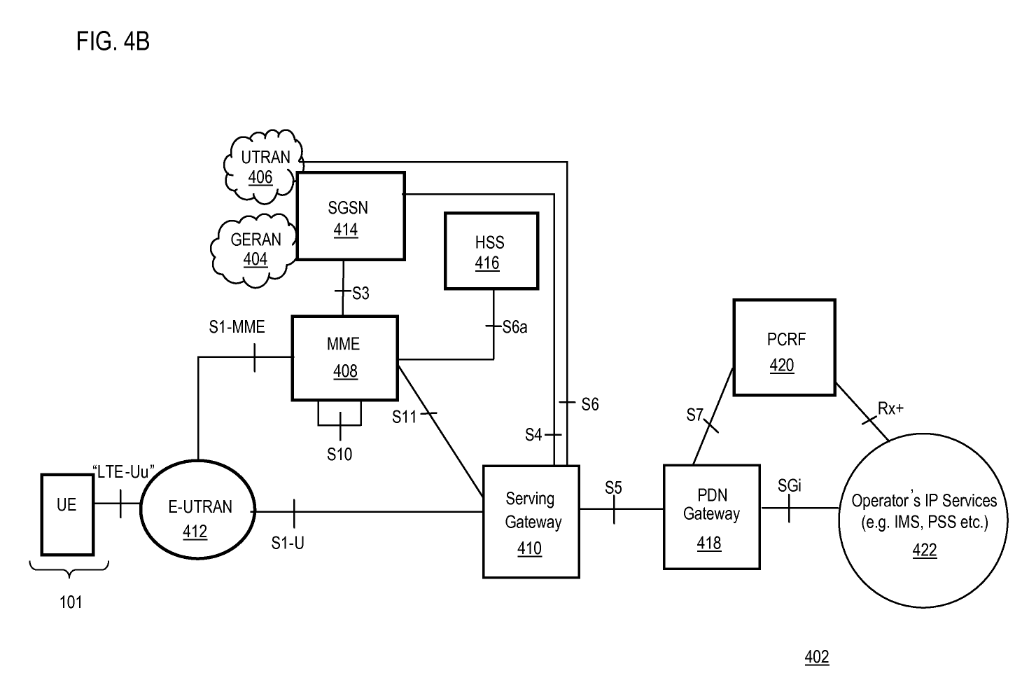

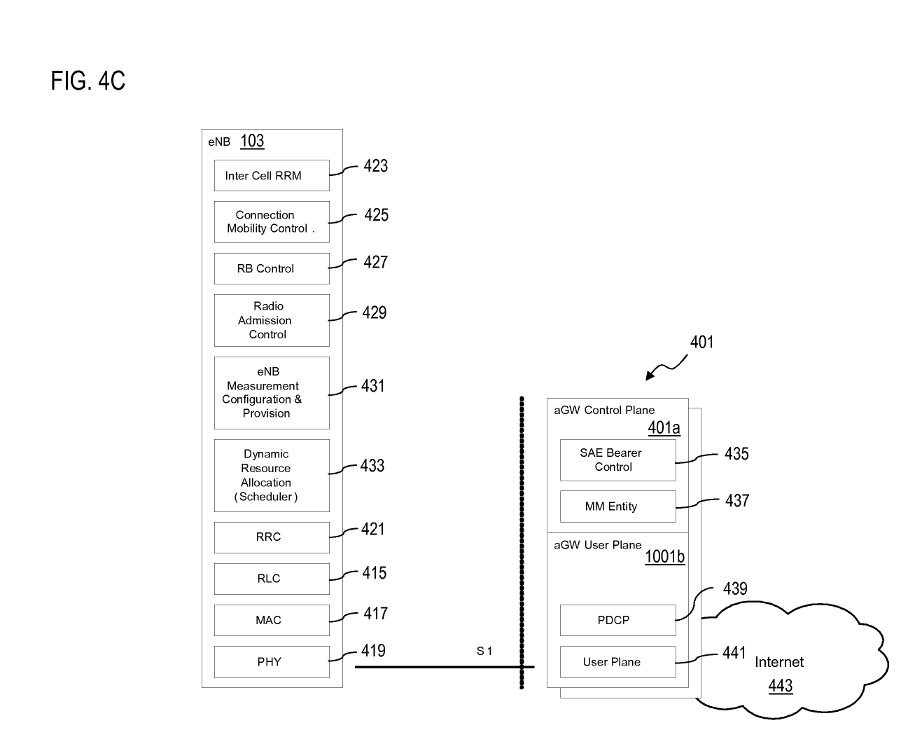

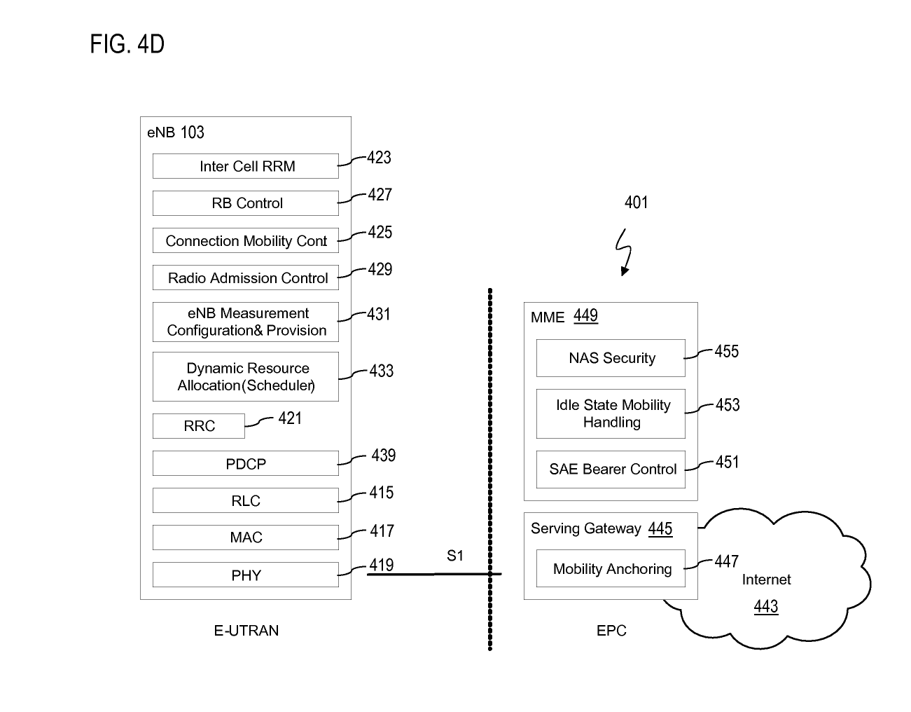

FIG. 1 is a diagram of a communication system capable of dynamically configuring a radio transmission frame pattern, according to an exemplary embodiment. As shown in FIG. 1, a communication system 100 includes one or more user equipment (UEs) 101 communicating with a base station 103, which is part of an access network (not shown) (e.g., 3GPP LTE or E-UTRAN, etc.). Under the 3GPP LTE architecture (as shown in FIGS. 4A-4D), the base station 103 is denoted as an enhanced Node B (eNB) 103. The UE 101 can be any type of mobile stations, such as handsets, terminals, stations, units, devices, multimedia tablets, Internet nodes, communicators, Personal Digital Assistants (PDAs) or any type of interface to the user (such as “wearable” circuitry, etc.). The UE 101 includes a transceiver 105 and an antenna system 107 that couples to the transceiver 105 to receive or transmit signals from the base station 103. The antenna system 107 can include one or more antennas. For the purposes of illustration, the time division duplex (TDD) mode of 3GPP is described herein; however, it is recognized that other modes can be supported, e.g., frequency division duplex (FDD).

As with the UE 101, the base station 103 employs a transceiver 109, which transmits information to the UE 101. Also, the base station 103 can employ one or more antennas 111 for transmitting and receiving electromagnetic signals. For instance, the Node B 103 may utilize a Multiple Input Multiple Output (MIMO) antenna system, whereby the Node B 103 can support multiple antenna transmit and receive capabilities. This arrangement can support the parallel transmission of independent data streams to achieve high data rates between the UE 101 and Node B 103. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access)) with cyclic prefix for the uplink (UL) transmission scheme.

In one embodiment, the system 100 of FIG. 1 is, for example, a small communication cell (e.g., a home eNB 103 or a closed subscriber group (CSG) cell) that is connected to a wide area network through, for instance, an internet connection over the data network 113. The cell may be deployed independently from a macro layer. Although the system 100 of FIG. 1 is described with respect to this small cell system, it is contemplated that the described frame configuration approach is applicable to any wireless communication system regardless of size.

Communications between the UE 101 and the base station 103 (and thus, the communication network (not shown) of the system 100) is governed, in part, by the configuration of the radio transmission frame used by the UE 101 and base station 103. By way of example, an FDD radio transmission frame includes ten subframes that are available for downlink transmissions and ten subframes that are available for uplink transmissions in each 10 ms interval. Uplink and downlink transmissions are separated in the frequency domain. In half-duplex FDD operation, the UE 101 transmit (Tx) and receive (Rx) operations are sequential, but in normal (i.e., full-duplex) FDD operation, the Tx and Rx operations may occur in parallel.

In LTE, the base station 103 uses, for example, TDD in the radio interface. Generally, the TDD radio transmission frame pattern is (e.g., see Table 2 below for exemplary radio frame patterns) semi-static (i.e., changes very infrequently), and usually all cells in one geographical area of the same carrier have the same radio transmission frame pattern. The operator of the network selects a suitable frame structure (e.g., specifying a specific uplink/downlink pattern for the transmission frame) based on the best compromise that will use the network spectrum in, for instance, a cellular network in a cost effective and efficient manner. Under a traditional system, however, the network may not be able to adapt the radio transmission frame to the most efficient format for a given communication traffic load within a specific cell because the radio frame pattern is set to be the best compromise for use across multiple cells rather a specific cell.

The approach described herein addresses this problem by providing for the dynamic configuration a radio transmission frame pattern to use network resources more efficiently under varying communication traffic loads within a cell. The ability to dynamically configure a transmission frame pattern is particularly effective in small cell systems that are connected to a wide area network through an internet connection because the configuration of smaller cells are generally more flexible, but the approach is applicable to larger systems as well. For example, under this approach, the frame configuration module 115 of the base station 103 can dynamically change the TDD frame structure to a structure that can achieve the most efficient result (e.g., achieve the best throughput using the same resources) for a given communication traffic load. This reconfiguration of the frame structure is then signaled to the frame configuration module 117 of the UE 101. It is contemplated that any other algorithm for determining a TDD frame structure can be used. In addition, the frame structure may be set by request from the UE 101 or the frame configuration module 117 of the UE 101 within a cell based on the type of traffic selected by a user (e.g., internet browsing, uploading of picture files, voice call, etc.).

As shown in FIG. 1, in one embodiment, the type of communication traffic depends, at least in part, on the application 119 that is being accessed over the data network 113. For example, application 119a (e.g., a web server) supports a traffic type 121a that is directed to internet browsing and related content, and application 119n (e.g., an instant messaging application) supports a traffic type 121n that is directed to real-time text-based communication. Each of the traffic types 121a and 121n is associated with different characteristics (e.g., required Quality of Service, priority, delay tolerance, data volume, etc.) that are best suited to different frame structures or configurations.

In other words, the approach enables the base station 103 to dynamically modify, or change the currently used frame pattern (e.g., TDD UL/DL configuration) within the cell. In exemplary embodiments, either the base station 103 (e.g., via the frame configuration module 115) or the UE 101 (e.g., via the frame configuration module 117) may initiate frame reconfiguration. The change may, for instance, be triggered by traffic needs or other similar criteria. Additionally, the change of frame pattern may be performed using radio resource control (RRC) signaling (e.g., using normal handover (HO) procedures or reusing already defined fixed TDD frame patterns and rules). The signaling may employ the already defined HO command (intra-cell)/RRC reconfiguration message. In certain embodiments, the RRC reconfiguration message (i.e., HO command) can be updated to include activation/starting time as to when to apply the new frame pattern. The message may also include a new information element (IE) indicating that the handover is an intra-cell/eNB type to indicate that although the frame pattern has changed, the cell or eNB 103 has not really changed. In other embodiments, a new RRC message dedicated to initiating a frame pattern change may be used.

By way of example, a UE 101 that receives a message indicating a frame pattern change uses the frame change information in the same way as when receiving existing IEs under the traditional system (e.g., in SystemInformationBlock 1 (SIB1), RadioResourceConfigCommon IE, or MobilityControlInformation IE). Therefore, the UE 101 would already be aware of the new (i.e., active) TDD frame pattern at the point of reconfiguration HO).

This approach permits access after the reconfiguration (e.g., HO) to be performed without reading the System information and without the Random Access (RACH) procedure. Traditionally, these two procedures are required under a typical HO process under TDD. By avoiding these two procedures, reconfiguration can be signaled using less overhead (i.e., made lighter in terms of UE 101 and eNB 103 signaling requirements).

In alternate embodiments, dynamic configuration of the frame pattern may be enabled by including either the RadioResourceConfigCommon or simply the TDD-Configuration in the RRCConnectionReconfiguration message (without MobilityControlInformation).

In another embodiment, an IE may be added to the RRC reconfiguration message to indicate that the handover is an intra-cell/eNB 103 type (i.e., the cell/eNB 103 has not really changed). The UE 101 thus already has the radio frame level synchronization and potentially the timing advance (TA). In this way, the UE 101 may access the network after reconfiguration without having to perform the access procedure in cases where the TA is still valid using the TDD configuration optionally included in the message.

Other embodiments may avoid the need for the intra-cell/eNB 103 IE by specifying a rule for the UE 101 to assume that when reconfiguration HO) occurs to the same cell/eNB 103—the current SIB and TA are potentially valid. By way of example, the existing RRCConnectionReconfiguration message may include a starting or activation time for the frame pattern change. This starting time indicates to the UE 101 when the RRCConnectionReconfiguration message should be used (i.e., activated) and thereby when the new frame pattern is valid or active.

For a UE 101 that is not in active RRC connection with the eNB 103, the timing of the change in frame pattern is not so important as long as certain parts of the downlink configuration are kept unchanged. The specific requirements depend on the system requirements for UE measurements, paging, and potentially also system information distribution for UEs 101 entering an active state. A UE 101 entering RRC connected mode from idle would get the currently used frame pattern during connection setup signaling. Moreover, a UE 101 in Idle mode could be informed about the changed frame pattern through normal system information change mark handling procedures.

The intra-cell HO indication is also useful in FDD mode (e.g., when the COUNT value wraps around and the HO is needed to renew security keys, or a new data radio bearer identification (DRB ID) is needed because the DRB ID has expired).

Table 1 below provides au example of using the RRC reconfiguration message to signal a frame pattern change by illustrating an exemplary IE structure.

TABLE 1
RRCConnectionReconfiguration Message (excl. MobilityControlInformation)

StartingTime/ActivationTime
RadioResourceConfigCommon

TDD-Configuration

subframeAssignment ENUMERATED {sa0, sa1, sa2, sa3, sa4, sa5,

sa6},
specialSubframePatterns ENUMERATED {ssp0, ssp1, ssp2, ssp3, ssp4,ssp5, ssp6,
ssp7,ssp8}.
RRCConnectionReconfiguration Message (incl. MobilityControlInformation)

StartingTime/ActivationTime
MobilityControlInformation

RadioResourceConfigCommon

TDD-Configuration

subframeAssignment ENUMERATED {sa0, sa1, sa2, sa3,

sa4, sa5, sa6},

specialSubframePatterns ENUMERATED {ssp0, ssp1, ssp2, ssp3, ssp4,ssp5, ssp6,

ssp7,ssp8}.
TDD-Configuration field descriptions
subframeAssignment
Indicates frame pattern (i.e., DL/UL subframe configuration) where sa0 points to Configuration 0,
sa1 to Configuration 1 etc. as specified in Table 2 below.
specialSubframePatterns
Indicates Configuration where ssp0 point to Configuration 0, ssp1 to Configuration 1 etc. as
specified in Table 3 below
StartingTime/ActivationTime
Indicates the time at which the new configuration shall be taken into use.

TABLE 2

| | Downlink- | | | | | | | | | | |
|---|---|---|---|---|---|---|---|---|---|---|---|
| | to-Uplink | | | | | | | | | | |
| Uplink- | periodicity | | | | | | | | | | |
| downlink | Switch- | Subframe number | | | | | | | | | |
| configuration | point | 0 | 1 | 2 | 3 | 4 | 5 | 6 | 7 | 8 | 9 |
| sa0 | 5 ms | D | S | U | U | U | D | S | U | U | U |
| sa1 | 5 ms | D | S | U | U | D | D | S | U | U | D |
| sa2 | 5 ms | D | S | U | D | D | D | S | U | D | D |
| sa3 | 10 ms | D | S | U | U | U | D | D | D | D | D |
| sa4 | 10 ms | D | S | U | U | D | D | D | D | D | D |
| sa5 | 10 ms | D | S | U | D | D | D | D | D | D | D |
| sa6 | 5 ms | D | S | U | U | U | D | S | U | U | D |

TABLE 3

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special subframe | | cyclic prefix | cyclic prefix | | cyclic prefix | cyclic prefix |
| configuration | DwPTS | in uplink | in uplink | DwPTS | in uplink | in uplink |
| ssp0 | 6592 · Tₛ | 2192 · Tₛ | 2560 · Tₛ | 7680 · Tₛ | 2192 · Tₛ | 2560 · Tₛ |
| ssp1 | 19760 · Tₛ | | | 20480 · Tₛ | | |
| ssp2 | 21952 · Tₛ | | | 23040 · Tₛ | | |
| ssp3 | 24144 · Tₛ | | | 25600 · Tₛ | | |
| ssp4 | 26336 · Tₛ | | | 7680 · Tₛ | 4384 · Tₛ | 5120 · Tₛ |
| ssp5 | 6592 · Tₛ | 4384 · Tₛ | 5120 · Tₛ | 20480 · Tₛ | | |
| ssp6 | 19760 · Tₛ | | | 23040 · T_{S} | | |
| ssp7 | 21952 · Tₛ | | | — | — | — |
| ssp8 | 24144 · Tₛ | | | — | — | — |

The example of Table 1 does not include the intra-cell/eNB 103 reconfiguration bit indication. This indication, in another embodiment, could be added or the UE 101 behavior as described above can be provided by rule. For example, the UE 101 can assume intra-cell/eNB 103 reconfiguration when the target cell in the RRCConnectionReconfiguration message is on the same frequency and has the same physical cell (PCI). In other words, such a target cell is considered to be an identical cell (e.g., same frequency and PCI), and therefore, can be similarly reconfigured.

Table 2 lists the seven different frame patterns (e.g., UL/DL patterns) that have been predefined for TDD operations (as detailed in TS 36.211 v8.5.0, “Evolved Universal Terrestrial Radio Access (E-UTRA); Physical Channels and Modulation”; which is incorporated herein by reference in its entirety). The pattern periodicity is either 5 ms or 10 ms with the exception of the last pattern, which is a combination of the first two 5-ms patterns. The patterns include normal downlink (D) and uplink (U) subframes, and a special subframe frame (S) per period. Each S subframe includes three variable slots: a downlink pilot time slot (DwPTS), guard period (GP), and uplink pilot time slot (UpPTS). The total time allotted for an S subframe is 1 ms (like other subframes), but within the subframe the relative amounts of times allotted for the three component slots (e.g., DwPTS GP, and UpPTS) varies. The maximum amount of TDD synchronous H-ARQ processes is variable based on the selected radio frame pattern and is also different in the uplink and downlink.

Table 3 enumerates the different exemplary configurations predefined for the S subframe. Each configuration lists a time for the DwPTS and corresponding UpPTS. The time difference remaining from the specified DwPTS and UpPTS time slots in relation to the total 1 ms subframe length is reserved for the GP. The GP is reserved for timing alignment and occurs between the DwPTS and UpPTS slots. Generally, a larger time block allotted for timing alignment in the GP allows the eNB 103 to operate in a larger radius.

In certain embodiments, the new configuration need not be signaled. Instead, for example, the eNB 103 may change the System Information, wherein the UE 101 reads the information from SIB1 (SystemInformationBlock1) after the HO to the same cell (i.e. intra-cell HO).

In other embodiments, a combination of dedicated, signaling and SIB change indication can be used where there are UEs 101 present in the cell in both idle and active modes. Active mode UEs 101 will receive the reconfiguration information (e.g., in an RRC reconfiguration message) while idle mode UEs 101 would get the information via the SIB1. Paging indication of changed System information could be given by the eNB 103 if needed to supplement normal SIB1 refresh procedures.

If the new frame pattern is included in the RRC reconfiguration message, the UE 101 would not need to read the System Information before access. An additional bit, for instance, could be added to the RRC reconfiguration message to indicate that access after HO is allowed without reading of the SIB1. The information contained in the SIB1 is already stored in the UE 101 and should be available for the UE 101 to access. This stored information may need to be updated in accordance with the information received in the HO command. Some RACH parameters may have to be reread if they are expired in accordance with RRC procedure specifications. Alternatively, RACH parameters may be left out of the HO configuration message entirely. In this case, eNB 103 scheduling enables the HO without RACH after the HO. For instance, the eNB 103 may schedule uplink resources (e.g., for the HO configuration message) directly to the UE 101 without the UE 101 performing RACH prior to scheduling. Since the UE 101 has already stored the value tag of the System Information (SI) messages, it does not need to reread the SI messages. The idle mode terminals receive the indication of a changed frame pattern by, for example, a paging message including the SystemInfoModification IE.

Typically, the base station 103 and UE 101 regularly exchange control information. Such control information, in an exemplary embodiment, is transported over a control channel on, for example, the downlink from the base station 103 to the UE 101. By way of example, a number of communication channels are defined for use in the system 100 of FIG. 1. The channel types include: physical channels, transport channels, and logical channels. For instance in LTE system, the physical channels include, among others, a Physical Downlink Shared channel (PDSCH), Physical Downlink Control Channel (PDCCH), Physical Uplink Shared Channel (PUSCH), and Physical Uplink Control Channel (PUCCH). The transport channels can be defined by how they transfer data over the radio interface and the characteristics of the data. In LTE downlink, the transport channels include, among others, a broadcast channel (BCH), paging channel (PCH), and Down Link Shared Channel (DL-SCH). In LTE uplink, the exemplary transport channels are a Random Access Channel (RACH) and UpLink Shared Channel (UL-SCH). Each transport channel is mapped to one or more physical channels according to its physical characteristics.

Each logical channel can be defined by the type and required Quality of Service (QoS) of information that it carries. In LTE system, the associated logical channels include, for example, a broadcast control channel (BCCH), a paging control channel (PCCH), Dedicated Control Channel (DCCH), Common Control Channel (CCCH), Dedicated Traffic Channel (DTCH), etc.

In LTE system, the BCCH (Broadcast Control Channel) can be mapped onto both BCH and DL-SCH. As such, this is mapped to the PDSCH; the time-frequency resource can be dynamically allocated by using L1/L2 control channel (PDCCH). In this case, BCCH (Broadcast Control Channel)-RNTI (Radio Network Temporary Identifier) is used to identify the resource allocation information.

To ensure accurate delivery of information between the eNB 103 and the UE 101, the system of FIG. 1 utilizes error detection in exchanging information, e.g., Hybrid ARQ (HARQ). HARQ is a concatenation of Forward Error Correction (FEC) coding and an Automatic Repeat Request (ARQ) protocol. Automatic Repeat Request (ARQ) is an error recovery mechanism used on the link layer. As such, this error recovery scheme is used in conjunction with error detection schemes (e.g., CRC (cyclic redundancy check)), and is handled with the assistance of error control logic 127 and 129 within the eNB 103 and UE 101, respectively. The HARQ mechanism permits the receiver (e.g., UE 101) to indicate to the transmitter (e.g., eNB 103) that a packet or sub-packet has been received incorrectly, and thus, requests the transmitter to resend the particular packet(s).

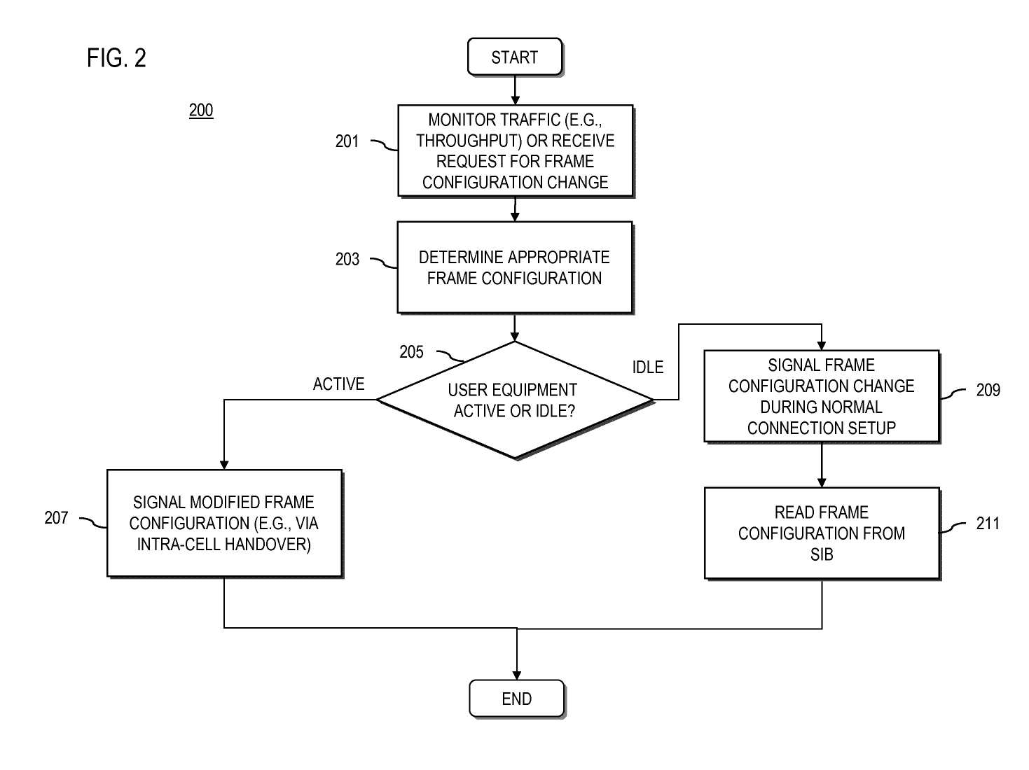

FIG. 2 is a flowchart of a process for dynamically configuring a radio transmission frame pattern, according to an exemplary embodiment. As shown in the process 200, the eNB 103 monitors the data throughput between the eNB 103 and the UE 101 to assist the eNB 103 in determining whether the current transmission frame pattern is the most effective use of network resources (step 201). In certain embodiments, the monitoring of data throughput may include reports from the eNB 103, the UE 101, or both. These reports, for instance, describe characteristics of the monitored communication traffic including communication type (e.g., internet browsing, uploading files, downloading files, real-time communication, delay tolerance, number of participants, etc.). In addition or alternatively, the UE 101 may be configured to request a specific frame configuration based on anticipated communication traffic type (e.g., internet browsing, uploading of picture files, etc.). Each type of communication traffic may have, for instance, a predefined frame pattern that is most effective for that particular traffic type. Based on monitoring and/or specific request by the UE 101, the eNB 103 determines the most appropriate frame pattern to make cost effective and efficient use of the network spectrum (step 203). It is contemplated that the eNB 103 may employ any algorithm to determine the appropriate frame pattern based on, for instance, the determined or monitored characteristics of the communication traffic.

In step 205, the eNB 103 determines whether the UE 101 is in an active mode or an idle mode with respect to the cell or communication network. Based on this determination, the eNB 103 signals the new frame pattern to the UEs 101 within the cell. As discussed previously, the form of signaling depends on whether each UE 101 is in an active or idle state. For example, if the UE is in an active state, the eNB may signal the changed frame pattern using an RRC reconfiguration message (e.g., as part of an intra-cell HO process) (step 207). More specifically, exemplary embodiments may employ entirely new RRC messages to indicate a change frame pattern or may use additional IEs on existing RRC messages. The key information to signal to the UE 101 includes the new frame pattern and starting or activation time of the change.

Signaling the changed frame pattern to idle UEs 101 may occur as part of normal connection setup procedures (step 209) using, for instance, the SIB1 (step 211). If there are both active and idle UEs 101 within the cell, the eNB 103 may use a combination of procedures to signal the new frame pattern to all the UEs 101. The eNB 103 may then continue to monitor the communication traffic and/or listen for additional frame pattern change requests to determine whether additional frame pattern changes are necessary.

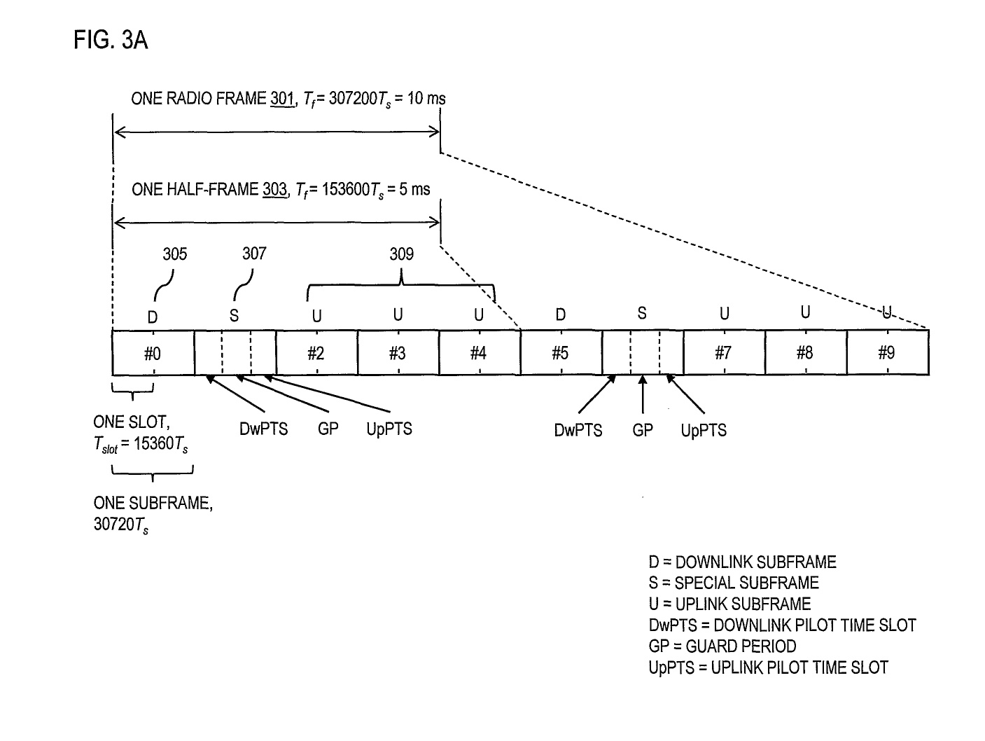

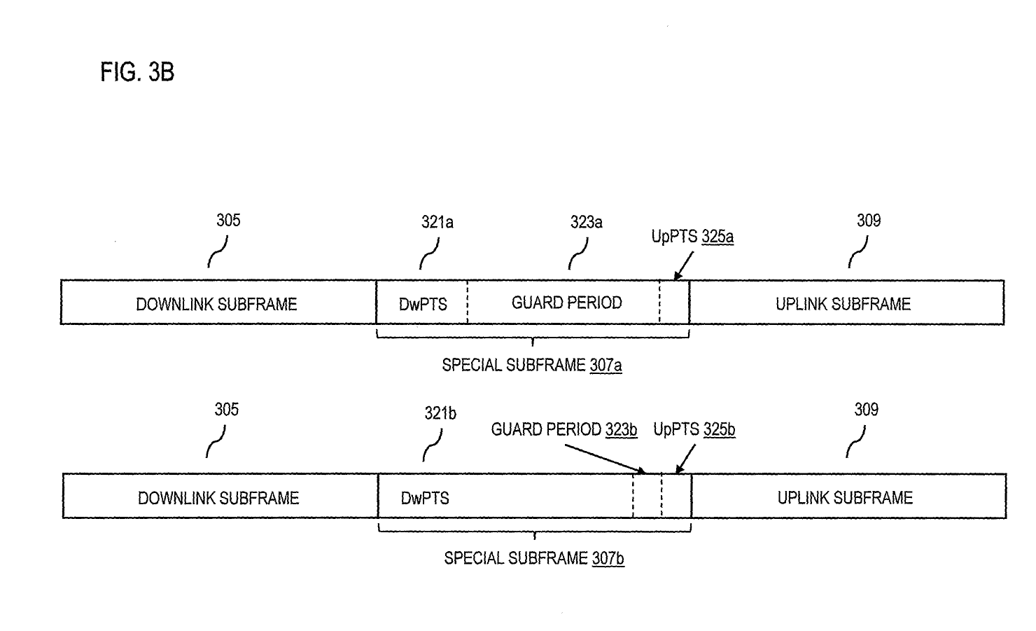

FIGS. 3A and 3B are diagrams of radio transmission frame structures, according to various exemplary embodiments. FIG. 3A depicts a standard TDD radio frame and FIG. 3B depicts the structure of a special subframe of the TDD radio frame. As shown in 3A, an exemplary TDD radio frame structure 301 is 10 ms in length and may consist of two 5-ms half-frames 303. Each frame 301 may be further divided into ten subframes numbered 0 to 9. In this example, the radio frame structure 301 is for a 1D/3U pattern (i.e., subframe 0 is reserved for a downlink (D) transmission 305, subframe 1 is reserved for a special subframe 307 (described in more detail below with respect to FIG. 3B), and the next three subframes (subframes 2-4) are reserved for uplink (U) transmissions 309; the pattern repeats for the second half-frame).

FIG. 3B depicts the structure of a special subframe (S) 307. The S subframe 307a includes three segments: a DwPTS slot 321a (i.e., a shortened downlink slot), guard period (GP) slot 323a, and UpPTS slot 325a (i.e., a shortened uplink slot). The DwPTS slot 321a contains the downlink reference signal (RS), physical synchronization channel (P-SCH), physical downlink control channel (PDCCH), physical downlink shared channel (PDSCH). The GP slot 323a is an empty slot used to prevent uplink/downlink interference and provide for timing alignment. The UpPTS slot 325a contains a short random access (RACH) and a configurable sounding reference signal (SRS). FIG. 3B also shows the range of variation of the TDD special subframe with the normal cyclic prefix. The eight predefined configurations for S subframe 307 is discussed with respect to Table 3 above. The guard period 321 length basically defines how large the TDD cell radios can be. For example, the S subframe 307b includes a shortened GP slot 323b (relative to the GP slot 323a). Accordingly, the DwPTS slot 321b is lengthened so that the overall duration of the S subframe 307b remains at 1 ms. The UpPTS slot 325b remains the same as the UpPTS slot 325a. The relative lengths of the DwPTS slot 321, GP slot 323, and UpPTS slot 325 can be varied according to the configurations presented in Table 3.

The process for dynamically configuring a radio transmission frame can be performed over a variety of networks; an exemplary system is described with respect to FIGS. 4A-4D.

FIGS. 4A-4D are diagrams of communication systems having exemplary long-term evolution (LTE) architectures, in which the user equipment (UE) and the base station of FIG. 1 can operate, according to various exemplary embodiments of the invention. By way of example (shown in FIG. 4A), a base station (e.g., destination node) 103 and a user equipment (UE) 101 (e.g., source node) can communicate in system 400 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 400 is compliant with 3GPP LTE, entitled “Long Term Evolution of the 3GPP Radio Technology” (which is incorporated herein by reference in its entirety). As shown in FIG. 4A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 401 are connected to the eNBs 103 in a full or partial mesh configuration using tunneling over a packet transport network (e.g., Internet Protocol (IP) network) 403. Exemplary functions of the MME/Serving GW 401 include distribution of paging messages to the eNBs 103, termination of U-plane packets for paging reasons, and switching of U-plane for support of UE mobility. Since the GWs 401 serve as a gateway to external networks, e.g., the Internet or private networks 403, the GWs 401 include an Access, Authorization and Accounting system (AAA) 405 to securely determine the identity and privileges of a user and to track each user's activities. Namely, the MME Serving Gateway 401 is the key control-node for the LTE access-network and is responsible for idle mode UE tracking and paging procedure including retransmissions. Also, the MME 401 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 4B, a communication system 402 supports GERAN (GSM/EDGE radio access) 404, and UTRAN 406 based access networks, E-UTRAN 412 and non-3GPP (not shown) based access networks, and is more fully described in TR 23.882, which is incorporated herein by reference in its entirety. A key feature of this system is the separation of the network entity that performs control-plane functionality (MME 408) from the network entity that performs bearer-plane functionality (Serving Gateway 410) with a well defined open interface between them S11. Since E-UTRAN 412 provides higher bandwidths to enable new services as well as to improve existing ones, separation of MME 408 from Serving Gateway 410 implies that Serving Gateway 410 can be based on a platform optimized for signaling transactions. This scheme enables selection of more cost-effective platforms for, as well as independent scaling of, each of these two elements. Service providers can also select optimized topological locations of Serving Gateways 410 within the network independent of the locations of MMEs 408 in order to reduce optimized bandwidth latencies and avoid concentrated points of failure.

As seen in FIG. 4B, the E-UTRAN (e.g., eNB) 412 interfaces with UE 101 via LTE-Uu. The E-UTRAN 412 supports LTE air interface and includes functions for radio resource control (RRC) functionality corresponding to the control plane MME 408. The E-UTRAN 412 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 408, as a key control node, is responsible for managing mobility UE identifies and security parameters and paging procedure including retransmissions. The MME 408 is involved in the bearer activation/deactivation process and is also responsible for choosing Serving Gateway 410 for the UE 101. MME 408 functions include Non Access Stratum (NAS) signaling and related security. MME 408 checks the authorization of the UE 101 to camp on the service provider's Public Land Mobile Network (PLMN) and enforces UE 101 roaming restrictions. The MME 408 also provides the control plane function for mobility between LTE and 2G/3G access networks with the S3 interface terminating at the MME 408 from the SGSN (Serving GPRS Support Node) 414.

The SGSN 414 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 408 and HSS (Home Subscriber Server) 416. The S10 interface between MMEs 408 provides MME relocation and MME 408 to MME 408 information transfer. The Serving Gateway 410 is the node that terminates the interface towards the E-UTRAN 412 via S1-U.

The S1-U interface provides a per bearer user plane tunneling between the E-UTRAN 412 and Serving Gateway 410. It contains support for path switching during handover between eNBs 103. The S4 interface provides the user plane with related control and mobility support between SGSN 414 and the 3GPP Anchor function of Serving Gateway 410.

The S12 is an interface between UTRAN 406 and Serving Gateway 410. Packet Data Network (PDN) Gateway 418 provides connectivity to the UE 101 to external packet data networks by being the point of exit and entry of traffic for the UE 101. The PDN Gateway 418 performs policy enforcement, packet filtering for each user, charging support, lawful interception and packet screening. Another role of the PDN Gateway 418 is to act as the anchor for mobility between 3GPP and non-3GPP technologies such as WiMax and 3GPP2 (CDMA 1X and EvDO (Evolution Data Only)).

The S7 interface provides transfer of QoS policy and charging rules from PCRF (Policy and Charging Role Function) 420 to Policy and Charging Enforcement Function (PCEF) in the PDN Gateway 418. The SGi interface is the interface between the PDN Gateway and the operator's IP services including packet data network 422. Packet data network 422 may be an operator external public or private packet data network or an intra operator packet data network, e.g., for provision of IMS (IP Multimedia Subsystem) services. Rx+ is the interface between the PCRF and the packet data network 422.

As seen in FIG. 4C, the eNB 103 utilizes an E-UTRA (Evolved Universal Terrestrial Radio Access) (user plane, e.g., RLC (Radio Link Control) 415, MAC (Media Access Control) 417, and PHY (Physical) 419, as well as a control plane (e.g., RRC 421)). The eNB 103 also includes the following functions: Inter Cell RRM (Radio Resource Management) 423, Connection Mobility Control 425, RB (Radio Bearer) Control 427, Radio Admission Control 429, eNB Measurement Configuration and Provision 431, and Dynamic Resource Allocation (Scheduler) 433.

The eNB 103 communicates with the aGW 401 (Access Gateway) via an S1 interface. The aGW 401 includes a User Plane 401a and a Control plane 401b. The control plane 401b provides the following components: SAE (System Architecture Evolution) Bearer Control 435 and MM (Mobile Management) Entity 437. The user plane 401b includes a PDCP (Packet Data Convergence Protocol) 439 and a user plane functions 441. It is noted that the functionality of the aGW 401 can also be provided by a combination of a serving gateway (SGW) and a packet data network (PDN) GW. The aGW 401 can also interface with a packet network, such as the Internet 443.

In an alternative embodiment, as shown in FIG. 4D, the PDCP (Packet Data Convergence Protocol) functionality can reside in the eNB 103 rather than the GW 401. Other than this PDCP capability, the eNB functions of FIG. 4C are also provided in this architecture.

In the system of FIG. 4D, a functional split between E-UTRAN and EPC (Evolved Packet Core) is provided. In this example, radio protocol architecture of E-UTRAN is provided for the user plane and the control plane. A more detailed description of the architecture is provided in 3 GPP TS 36.300.

The eNB 103 interfaces via the S1 to the Serving Gateway 445, which includes a Mobility Anchoring function 447. According to this architecture, the MME (Mobility Management Entity) 449 provides SAE (System Architecture Evolution) Bearer Control 451, Idle State Mobility Handling 453, and NAS (Non-Access Stratum) Security 455.

One of ordinary skill in the art would recognize that the processes for dynamically modifying a transmission frame may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

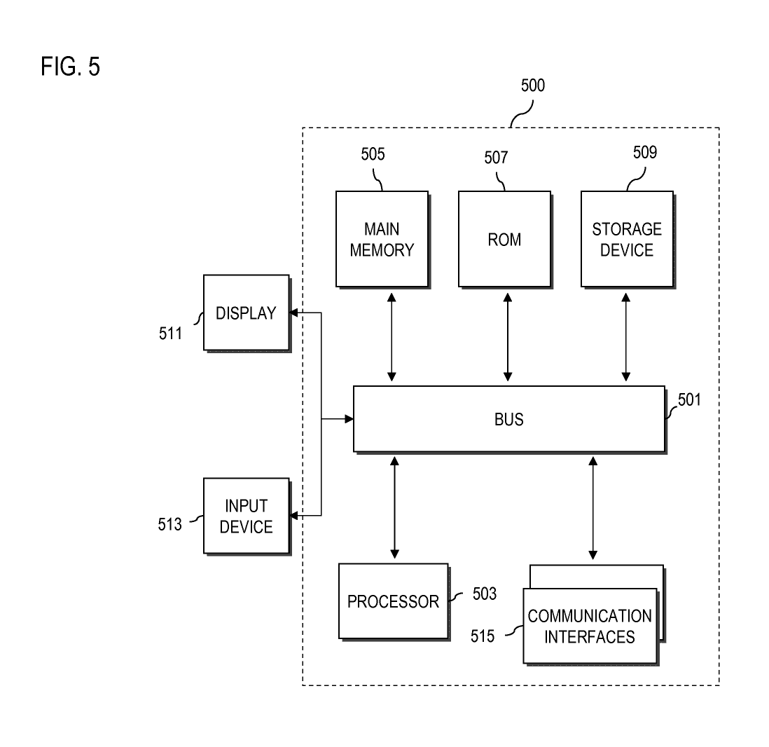

FIG. 5 illustrates exemplary hardware upon which various embodiments of the invention can be implemented. A computing system 500 includes a bus 501 or other communication mechanism for communicating information and a processor 503 coupled to the bus 501 for processing information. The computing system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computing system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computing system 500 may be coupled via the bus 501 to a display 511, such as a liquid crystal display, or active matrix display, for displaying information to a user. An input device 513, such as a keyboard including alphanumeric and other keys, may be coupled to the bus 501 for communicating information and command selections to the processor 503. The input device 513 can include a cursor control, such as a mouse, a trackball, or cursor direction keys, for communicating direction information and command selections to the processor 503 and for controlling cursor movement on the display 511.

According to various embodiments of the invention, the processes described herein can be provided by the computing system 500 in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 500 also includes at least one communication interface 515 coupled to bus 501. The communication interface 515 provides a two-way data communication coupling to a network link (not shown). The communication interface 515 sends and receives electrical, electromagnetic, or optical signals that carry digital data streams representing various types of information. Further, the communication interface 515 can include peripheral interface devices, such as a Universal Serial Bus (USB) interface, a PCMCIA (Personal Computer Memory Card International Association) interface, etc.

The processor 503 may execute the transmitted code while being received and/or store the code in the storage device 509, or other non-volatile storage for later execution. In this manner, the computing system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

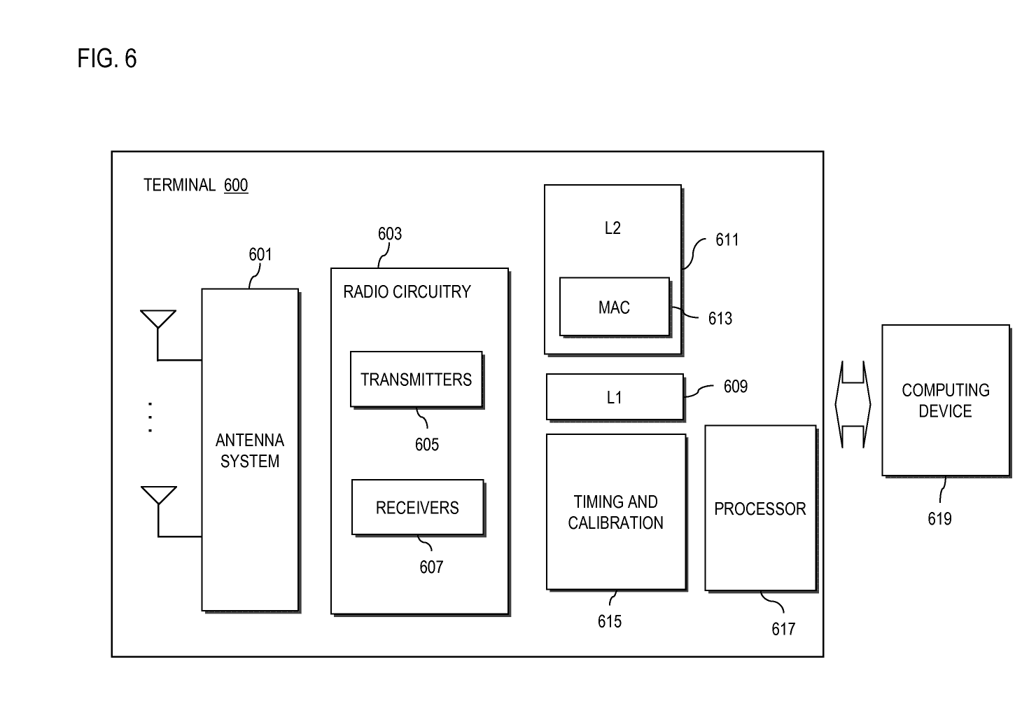

FIG. 6 is a diagram of exemplary components of a user terminal configured to operate in the systems of FIGS. 4A-4D, according to an embodiment of the invention. A user terminal 600 includes an antenna system 601 (which can utilize multiple antennas) to receive and transmit signals. The antenna system 601 is coupled to radio circuitry 603, which includes multiple transmitters 605 and receivers 607. The radio circuitry encompasses all of the Radio Frequency (RF) circuitry as well as base-band processing circuitry. As shown, layer-1 (L1) and layer-2 (L2) processing are provided by units 609 and 611, respectively. Optionally, layer-3 functions can be provided (not shown). L2 unit 611 can include module 613, which executes all Medium Access Control (MAC) layer functions. A timing and calibration module 615 maintains proper timing by interfacing, for example, an external timing reference (not shown). Additionally, a processor 617 is included. Under this scenario, the user terminal 600 communicates with a computing device 619, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the claims. Although features of the invention are expressed in certain combinations among the claims, it is contemplated that these features can be arranged in any combination and order.

1-45. (canceled)

46. A method comprising:
determining whether to modify a configuration of a transmission frame, including a time division duplex frame structure, for transmission over a cell;
modifying the configuration of the transmission frame for transmission over the cell based on the determination; and
signaling the modified configuration to a user equipment configured within the cell.

47. A method of claim 46, wherein the user equipment is active within the cell, the method further comprising:
generating a reconfiguration message that specifies the modified configuration, the reconfiguration message including a field for indicating an intra-cell or a base station handover procedure.

48. A method of claim 47, wherein the reconfiguration message specifies the modified configuration for an identical cell.

49. A method of claim 46, wherein the user equipment is idle within the cell, the method further comprising:
modifying system information associated with the cell to include the modified configuration.

50. A method of claim 46, further comprising:
receiving a request from a user equipment to perform the modifying of the configuration of the transmission frame,
wherein the modifying of the configuration of the transmission frame is performed based on the request.

51. A method of claim 46, wherein the modified configuration specifies an uplink/downlink pattern for the transmission frame.

52. A method of claim 46, wherein the communication traffic is transported over a data network.

53. An apparatus comprising:
a logic configured to determine whether to modify a configuration of a transmission frame, including a time division duplex frame structure, for transmission over a cell and to modify the configuration of the transmission frame for transmission over the cell based on the determination; and
a transceiver configured to signal the modified configuration to a user equipment configured within the cell.

54. An apparatus of claim 53, wherein the user equipment is active within the cell, and wherein the logic is further configured to generate a reconfiguration message that specifies the modified configuration, the reconfiguration message including a field for indicating an intra-cell or a base station handover procedure.

55. An apparatus of claim 54, wherein the reconfiguration message specifies the modified configuration for an identical cell.

56. An apparatus of claim 53, wherein the user equipment is idle within the cell, and wherein the logic is further configured to modify system information associated with the cell to include the modified configuration.

57. An apparatus of claim 53, wherein the transceiver is further configured to receive a request from a user equipment to perform the modifying of the configuration of the transmission frame, and wherein the modifying of the configuration of the transmission frame is performed based on the request.

58. An apparatus of claim 53, wherein the modified configuration specifies an uplink/downlink pattern for the transmission frame.

59. An apparatus of claim 53, wherein the communication traffic is transported over a data network.

60. An apparatus of claim 53, wherein the apparatus is a base station.

61. A method comprising:
receiving, within a cell, a message specifying reconfiguration of a transmission frame including a time division duplex frame structure,
wherein the reconfiguration is based on determining whether to modify a configuration of the transmission frame for transmission over the cell.

62. A method of claim 61, wherein the message includes a field for indicating an intra-cell or a base station handover procedure.

63. A method of claim 61, wherein the message specifies the reconfiguration of the transmission frame for an identical cell.

64. A method of claim 61, further comprising:
generating a request for modifying the configuration of the transmission frame.

65. A method of claim 61, wherein the reconfiguration specifies an uplink/downlink pattern for the transmission frame.
